(19) United States
(12) Patent Application Publication
(10) Pub. No.: US 2004/0254778 A1
(43) Pub. Date: Dec. 16, 2004

(54) Reconfigurable logic element with input swapping

(75) Inventors: Gilles Laurent, Boulogne (FR); Cyril Quennesson, Antony (FR); Olivier Filoche, Villiers sur Marne (FR)

Correspondence Address: BANNER & WITCOFF, LTD., TEN SOUTH WACKER DRIVE, SUITE 3000, CHICAGO, IL, 60606, US

(73) Assignee: Mentor Graphics Corporation, Wilsonville, OR

(21) Appl. No.: 10/460,701

(22) Filed: Jun. 12, 2003

(51) Int. Cl. G06F 9/455

(52) U.S. Cl. 703/25

(57) ABSTRACT

A novel reconfigurable logic element (RLE) architecture for use in an integrated circuit itself used in an emulation system is disclosed. The RLE has lookup table logic circuitry for implementing a function. In addition, the RLE contains multi-stage coupling logic circuitry correspondingly coupling RLE inputs to the inputs of the lookup table logic circuitry. This allows global routing of the emulation system by circuit design mapping software to be much more flexible, as the routing may be configured independently of those four input constraints due to the ability to reassign the inputs with the swapper.

### FIELD OF THE INVENTION

The present invention pertains to the field of reconfigurable logic circuitry. More particularly, this invention relates to the design and use of reconfigurable logic circuitry, such as special purpose Field Programmable Gate Array (FPGA) for use in emulation of integrated circuit (IC) designs.

### BACKGROUND OF THE INVENTION

With advances in integrated circuit technology, various technologies have been developed to aid circuit designers in designing and debugging highly complex integrated circuits. In particular, emulation systems comprising reconfigurable logic elements have been developed for circuit designers to “realize” their designs in hardware for more rapid verification of these designs.

The first generation of prior art emulation systems were typically formed using general purpose FPGAs. To emulate a circuit design on one of such emulation systems, the circuit design would be “realized” by compiling a formal description of the circuit design; partitioning the circuit design into subsets, mapping the various subsets to the reconfigurable logic resources of the FPGAs of various logic boards of the emulation system, and then configuring and interconnecting the reconfigurable logic resources. The partitioning and mapping operations would typically be performed on workstations that are part of, or complementary to, the emulation systems, while the configuration information would be correspondingly downloaded onto the logic boards hosting the FPGAs, and then onto the FPGAs.

With advances in integrated circuit and emulation technology, some late model emulation systems employ “FPGAs” specifically designed for emulation purposes. For example, during emulation, test stimuli are generated either on the workstation or on a service board of the emulation system under the control of the workstation. The test stimuli are transferred to the various logic boards for application to the realized circuitry of the IC design being emulated. Debugging information such as state data of various circuit elements, as well as signal states of interest of the IC design being emulated, would correspondingly be read out of the applicable FPGAs, and then transferred off the logic boards, for analysis on the workstation.

To support these debugging resources, as well as requirements for increased logic emulation capability in light of today's larger circuits, these special “FPGAs” or emulation ICs would typically include a substantial amount of on-chip reconfigurable logic elements, memory and debugging resources. Notwithstanding an increase of interconnects on the boards containing these emulation ICs, the dramatic increase in the number of resources in today's emulators results in a longer compile time to map an IC design to the reconfigurable emulation resources of an emulator. Thus, emulation resources with improved routability, and emulation systems using such improved routability emulation resources are desired.

### BRIEF SUMMARY OF THE INVENTION

The present invention provides methods and apparatuses that support a reconfigurable logic element (RLE) architecture for use in an emulation system. The RLE has lookup table logic circuitry for implementing a function. In addition, the RLE contains multi-stage coupling logic circuitry correspondingly coupling RLE inputs to the inputs of the lookup table logic circuitry. The present invention allows global routing of the emulation system by circuit design mapping software to be much more flexible, as the routing may be configured independently of input constraints due to the ability to reassign the inputs with a multistage coupling network. With one exemplary embodiment of the invention, the multistage coupling network utilizes six two-signal switching circuits, while a variation of the exemplary embodiment utilizes five two-signal switching circuits.

### BRIEF DESCRIPTION OF THE DRAWINGS

Illustrative embodiments of the present invention are illustrated by way of example in the accompanying drawings. The drawings are not, however, intended to limit the scope of the present invention. Similar references in the drawings indicate similar elements.

FIG. 1 illustrates the major functional blocks of an illustrative embodiment of a logic board in accordance with at least one aspect of the present invention;

FIG. 2 illustrates an illustrative embodiment of a hosted emulation IC of FIG. 1 in further detail, in accordance with at least one aspect of the present invention;

FIG. 3 illustrates a portion of an illustrative reconfigurable logic element (RLE);

FIG. 4 illustrates a portion of an illustrative embodiment of a reconfigurable logic element (RLE) including swapper logic in accordance with at least one aspect of the present invention;

FIG. 5 illustrates an emulation system as may be used in accordance with at least one aspect of the present invention;

FIG. 6 shows an illustrative embodiment of the swapper logic of FIG. 4;

FIG. 7 shows a table of illustrative input/output mappings;

FIG. 8 shows a table containing an illustrative configuration of a six configuration bit swapper;

FIG. 9 is a continuation of the table that is shown in FIG. 8;

FIG. 10 shows another illustrative embodiment of signal swapper logic of FIG. 4; and

FIG. 11 shows an illustrative emulation system that may be used with at least one aspect of the present invention.

### DETAILED DESCRIPTION

The following disclosure describes a novel architecture for a reconfigurable logic element (RLE) providing for increased routability of input signals associated with the RLE. The phrase “reconfigurable logic element” is used throughout this invention description, and is not intended to be limited to any particular reprogrammable logic block but should be interpreted, with the exception of the novel features of the disclosed invention, as one of any number of types of reconfigurable logic resource elements.

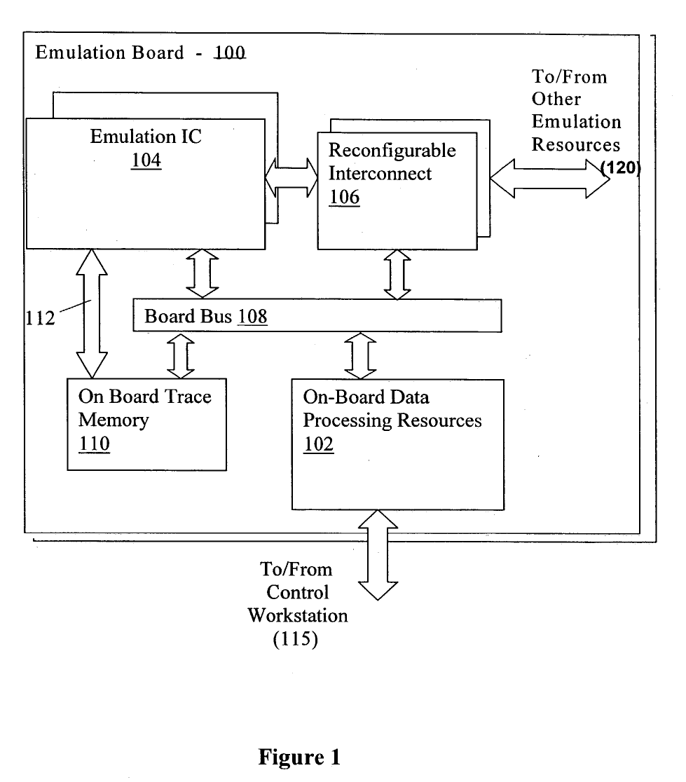

Referring to FIG. 1, an illustrative logic board 100 may include on-board data processing resources 102, on-board emulation ICs 104, on-board reconfigurable interconnects 106, board bus 108, and on-board trace memory 110 coupled to each other as shown (e.g. through board bus 108). Additionally, on-board emulation ICs 104 may also directly coupled to on-board trace memory 110. Logic board 100 may further include a plurality of I/O pins (not explicitly illustrated). A first subset of the I/O pins may be employed to couple selected ones of outputs of reconfigurable interconnects 106 to reconfigurable interconnects of other logic boards and ultimately to emulation resources 120 of the other logic boards (thereby coupling the emulation resources of the logic boards). A second subset of the I/O pins may be employed to couple data processing resources 102 to certain control resources, such as a control workstation 115.

One or more emulation ICs 104 may be used to “realize” the netlists of a digital or an analog IC design to be emulated. The emulation ICs 104 may each include reconfigurable logic resources and reconfigurable interconnect resources. Together, these are referred as emulation resources. These reconfigurable logic resources may include reconfigurable logic elements (RLEs), which also may be referred as configurable logic blocks (CLBs). Reconfigurable interconnects 106 may facilitate coupling of the emulation resources of the various emulation ICs 104 of the different logic boards 100 (or with the same logic board) employed to form an emulation system. Board bus 108 and trace memory 110 may perform their conventional functions of facilitating on-board communication/data transfers, and collection of signal states of the various emulation signals of the assigned partition of the IC design being emulated.

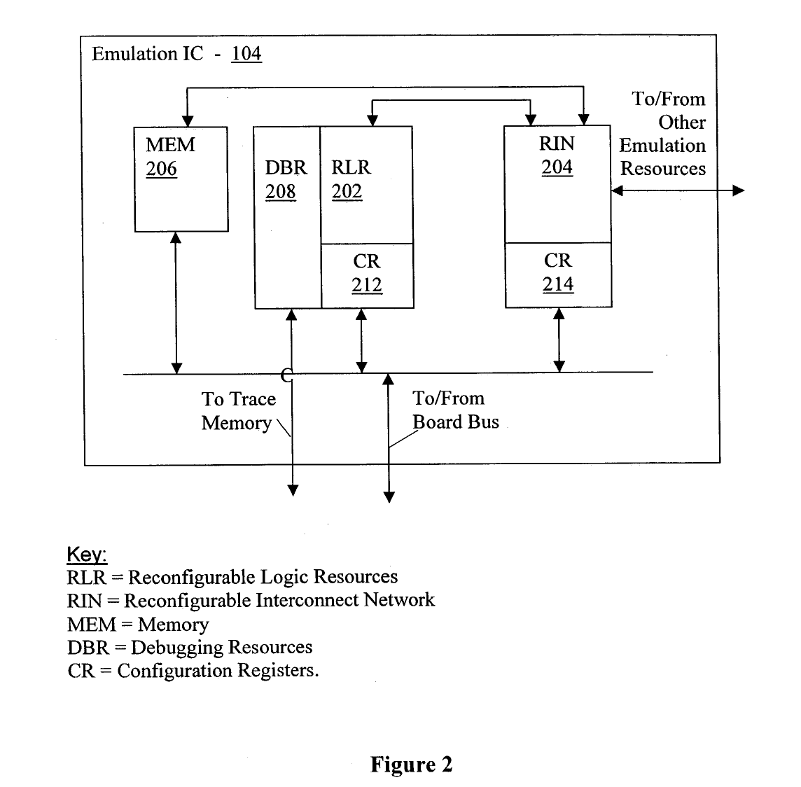

Referring to FIG. 2, emulation IC 104 may include reconfigurable logic resources (RLR) 202, reconfigurable interconnects (RIN) 204, emulation memory (MEM) 206, debugging resources (DBR) 208, and/or configuration registers (CR) 212 and 214 coupled to each other as shown. Reconfigurable logic resources 202 and emulation memory 206 may be used to “realize” circuit elements of a design (or a partition thereof) to be emulated. Reconfigurable interconnects 204 may be used to reconfigurably couple reconfigurable logic resources 202, memory 206, and/or other resources.

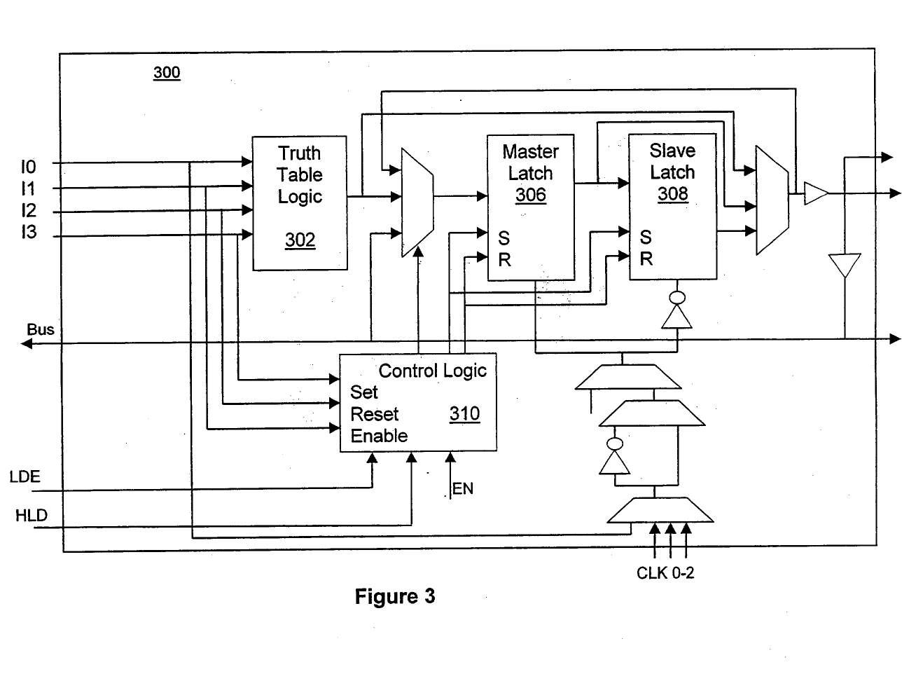

FIG. 3 illustrates an illustrative reconfigurable logic element (RLE), such as may be part of the reconfigurable logic resources 202. As shown, RLE 300 includes a multiple input-single output truth table 302, a pair of master-slave latches 306-308, control logic 310, and a plurality of input and output multiplexors coupled to each other as shown. Truth table 302 is used to reconfigurably generate an output in response to a provided set of inputs to the truth table. For the illustrated embodiment, truth table 302 has four inputs, 10-13, and a single output. However, any number of inputs and outputs may be used. Thus, truth table 302 may be programmed to realize any one of a plurality of different Boolean functions. As shown in the drawing, the inputs 10-13 to truth table 302 may also be used as control signals, such as set, reset, enable and/or clock, for master-slave latches 306, 308. Thus, input functions for I0-I3 may be fixed to the inputs of the RLEs.

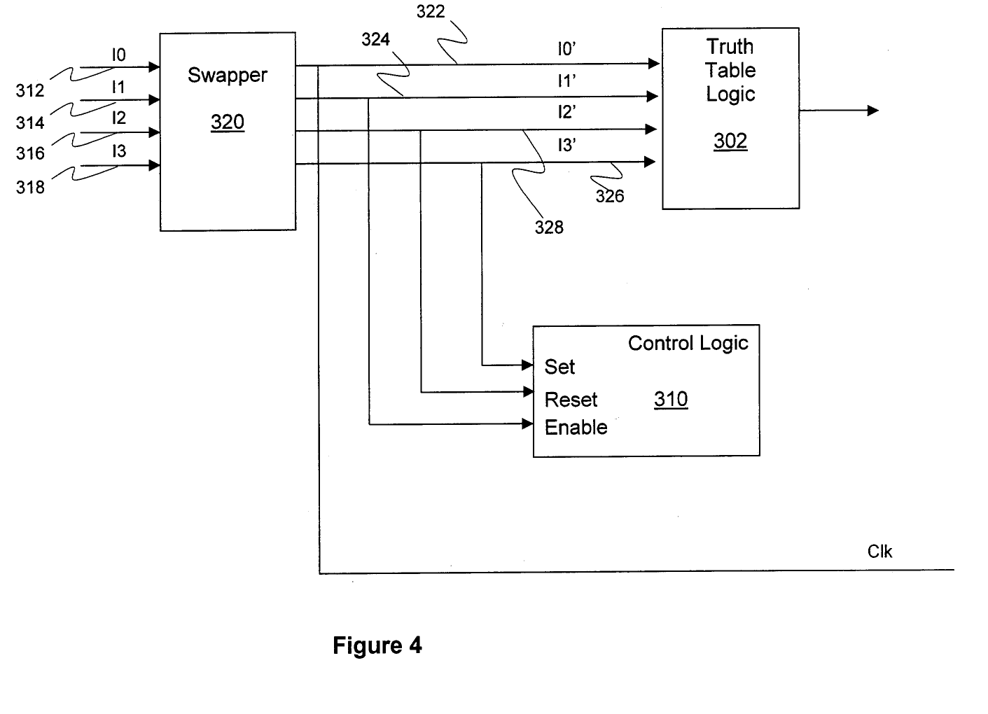

A swapper 320, as shown in FIG. 4, may be disposed between the inputs to the RLE 300 and the inputs of truth table 302. Swapper 320 may provide a translation between inputs and outputs. However, other embodiments of the invention may utilize other types of logic entities to provide a corresponding switching functionality such as a switch matrix, crossbar switch, and/or multiplexer configuration. In one embodiment, swapper 320 includes configurable logic and/or circuitry that “bijectively” maps RLE inputs I0-I3 312-318 to truth table input and clock control signals I0′-I3′ 322-328. A mapping is bijective if the mapping is one-to-one mapping and onto. In other words, for a mapping to be bijective, an input maps to only one output but not to a plurality of outputs. For example, the swapper 320 maps RLE input I0 312 to any of the swapper's 320 outputs, I0′-I3′ 322-328. Similarly, the remaining inputs I1-I3 314-318 may also be routed to any of outputs 10′-13′ 322-328 except for the output to which I0 312 was routed. Other embodiments of the invention may support other types of mapping, e.g., mapping an input to a plurality of outputs. In another embodiment, swapper 320 includes reconfigurable logic and/or circuitry to dynamically reconfigure the mapping between I0-I3 312-318 and I0′-I3′ 322-328. In another embodiment, the swapper 320 is reconfigurable independent from other configurable logic in the RLE, such as the truth table 302.

In comparison with other switching configurations, such as crossbar switch, the swapper 320 may utilize less electrical power and may require less circuit complexity because an input to the swapper 320 does not map to a plurality of outputs, as may be the case with other switching configurations. Moreover, the swapper 320 may facilitate configuring the emulation board 100 because the swapper 320 provides an additional degree of freedom for switching logic signals with the emulation board 100.

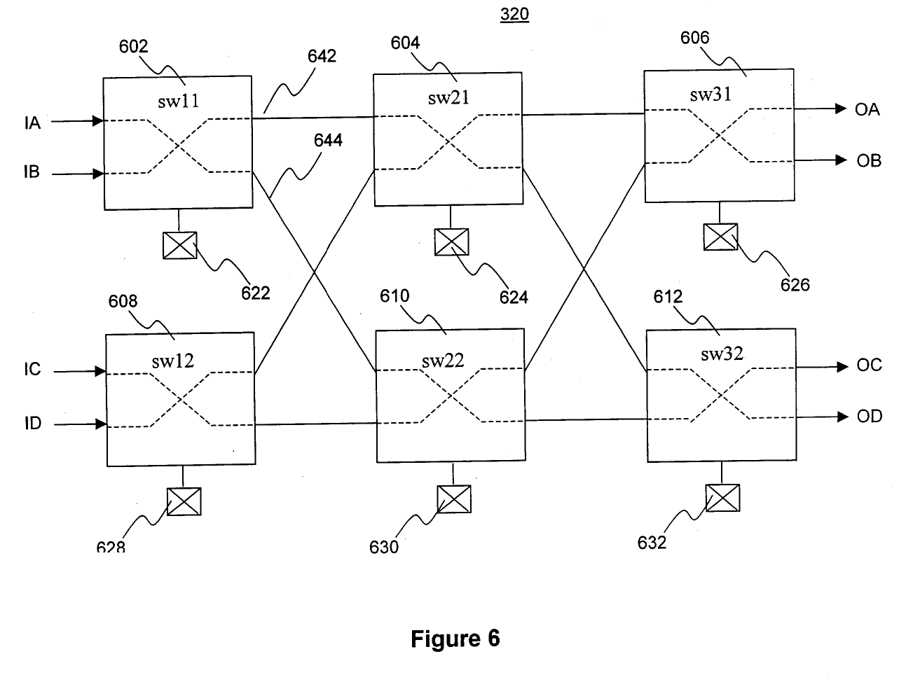

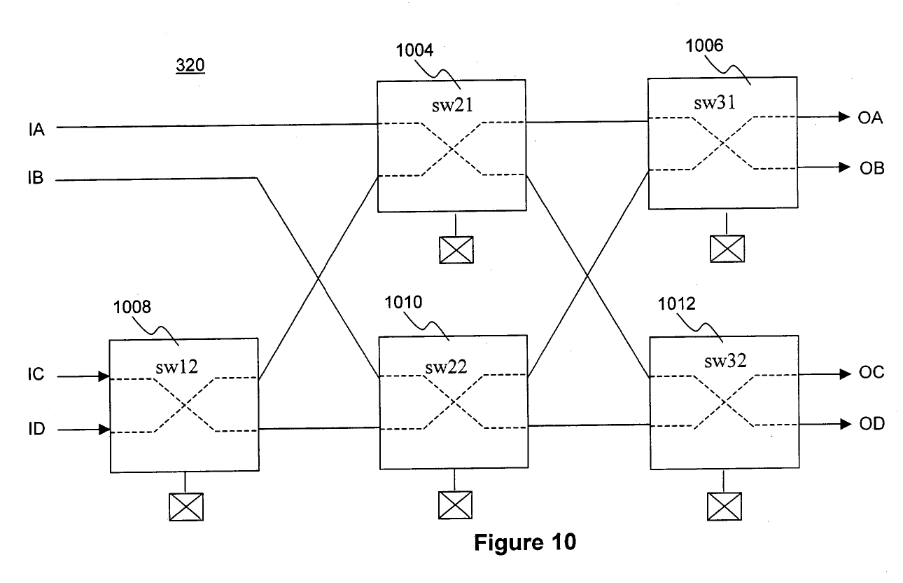

A swapper (as illustrated in FIGS. 6 and 10) may be used to support functionality (that is not limited to a RLE, e.g. RLE 300) in an emulation system. In an embodiment of the invention, a swapper may be incorporated in the reconfigurable interconnects 106. The reconfigurable interconnects 106 may be implemented with at least one swapper and may also include other switching configurations, e.g. a crossbar switch, with the at least one swapper.

The inputs to the RLE may be completely undifferentiated. Thus, for instance, any one of the inputs may couple, in addition to any of the inputs of the truth table logic 302, to any of the control signals feeding the control logic 310 of the sequential elements 306, 308.

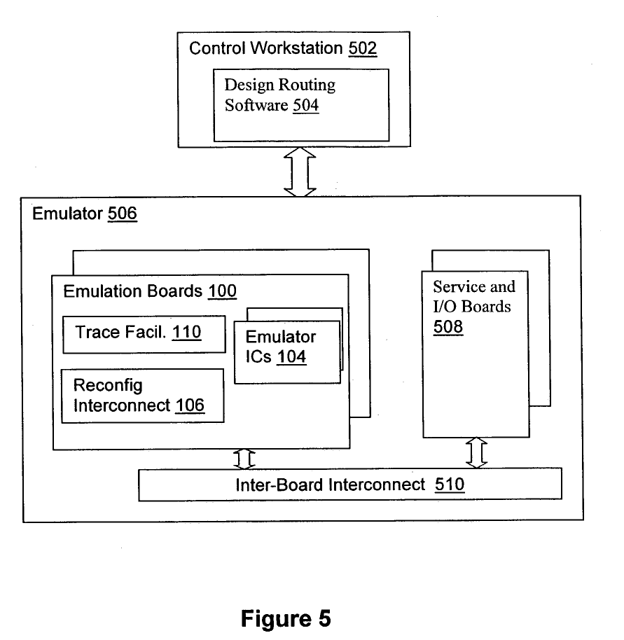

FIG. 5 shows an illustrative embodiment of an emulation system including an emulator 506 and a control workstation 502. In the embodiment shown, control workstation 502 contains design routing software 504. One of the functions of design routing software 504 is to “compile” a design to be emulated. Such a compilation may involve partitioning the design among the various reconfigurable logic resources of the emulator as well as routing signals that are required to connect these resources. As will be appreciated by one skilled in the art of placement and routing of designs, as design size increases, and correspondingly the utilization of reconfigurable logic resources on emulation ICs 104, the design routing software 504 will have a more difficult time performing the routing for a given placement of design elements in the reconfigurable logic resources on-board the emulation ICs 104. As the reconfigurable logic resources fill, routing time becomes exponentially longer. Even more problematic, as resources become very highly utilized, the routing software, at times, will not be able to perform the routing for a given placement. This inability to route results in the design routing software 504 having to reassign the design in the reconfigurable logic resources and perform another routing of the design. By adding a swapper (such as swapper 320) to the input of some or all of the RLEs, an additional resource may be provided to the design routing software 504 to enable it to globally route designs that would otherwise not be routable or, in the cases where designs are routable, to route those designs more quickly. This added routing ability is facilitated by the fact that, as previously discussed, some, if not all, of the inputs to the RLE may now be completely undifferentiated. In one embodiment of the present invention, the swapper logic may be reconfigured independently from other elements in the design, even on a RLE-by-RLE basis. A potential advantage of this embodiment is the ability to perform minor design tweaks in a design and have the design routing software 504 provide very quick design rerouting as a result of the ability to simply change the configuration in a single RLE or small number of RLEs.

FIG. 6 illustrates one embodiment of the swapper 320, in which the swapper 320 is an optimized matrix with reduced configurations points to create a one to one correspondence of four inputs to four outputs in a RLE used for emulation. In this embodiment, the logic circuitry 600 is a three-stage network of two-signal switching circuits 602-612 that, together, are capable of swapping four inputs, as discussed above, to four outputs. The six two-signal switching circuits 602-612 are each controlled by a configuration bit 622-632. Each configuration bit informs the appropriate two-signal switching circuit as to whether each input to the two-signal switching circuit should be passed through or switched. For example, in one embodiment, where configuration bit 622 is set to zero, two-signal switching circuit 602 is commanded to pass outputs directly through. As a result, output 642 of circuit 602 would be driven by input IA and output 644 would be driven by input IB. Conversely, where configuration bit 622 is set to one, the outputs 642, 644 are consequently swapped. In other words, input IA would drive output 644 while input 1B would drive output 642. Of course, the configuration bit may operate in an opposite manner as described above, i.e., a configuration bit set to zero is a command to switch and a configuration bit set to one is a command to pass.

The three stage network embodiment discussed above potentially provides an advantage over a standard crossbar interconnect for a four input to four output mapping. In such a traditional mapping, sixteen configuration bits would be required to configure the interconnect points of a four-to-four mapping. The above-described embodiment however, uses a scant six configuration bits and thus a savings of ten bits per RLE. Given that the current generation of emulation ICs have on the order of 1,000 RLEs on a device, a savings of on the order of 10,000 configuration bits per device may result. Moreover, with each emulation board 100 having upwards of forty-four emulation ICs 104, this may result in the savings of a half million configuration bits per emulation board in an emulation system. Consequently, the savings during the configuration and reconfiguration of the emulation system can be significant.

Although swapper 320 supports four inputs and four outputs as shown in FIG. 4, FIG. 6, and FIG. 10, swapper 320 may support a different number of inputs and outputs, which may be generalized to N inputs and M outputs, where N and M may be the same or different. A swapper may comprise an input interface, an output interface, and a switching module. The input interface accommodates the N inputs by providing mechanical and/or electrical connectivity for the N inputs. The output interface accommodates the M outputs by providing mechanical and/or electrical connectivity for the M outputs. A switching module, which couples to the input interface and to the output interface, bijectively maps the N inputs to the M outputs. Where there are a greater number of inputs than outputs, then it may be decided that some of the inputs may not be used. Similarly, where there are a greater number of outputs than inputs, then some of the outputs may not be used. For example, where N=4 and M=6, then two of the outputs could be left unused (e.g., not mapped to an input) or even tied to other of the outputs. Thus, the swapper in such an example may be considered to have four inputs and four outputs, as well as two extra unused outputs.

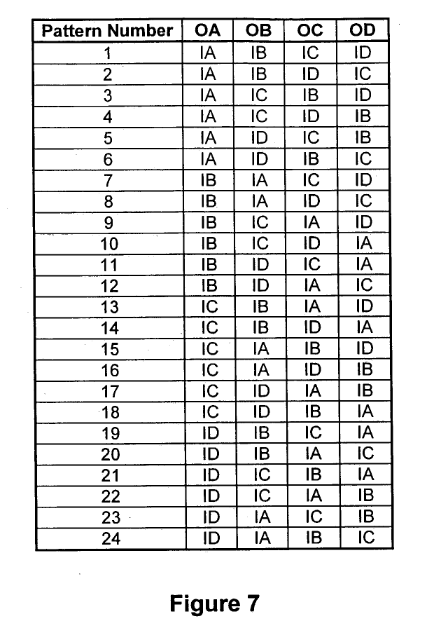

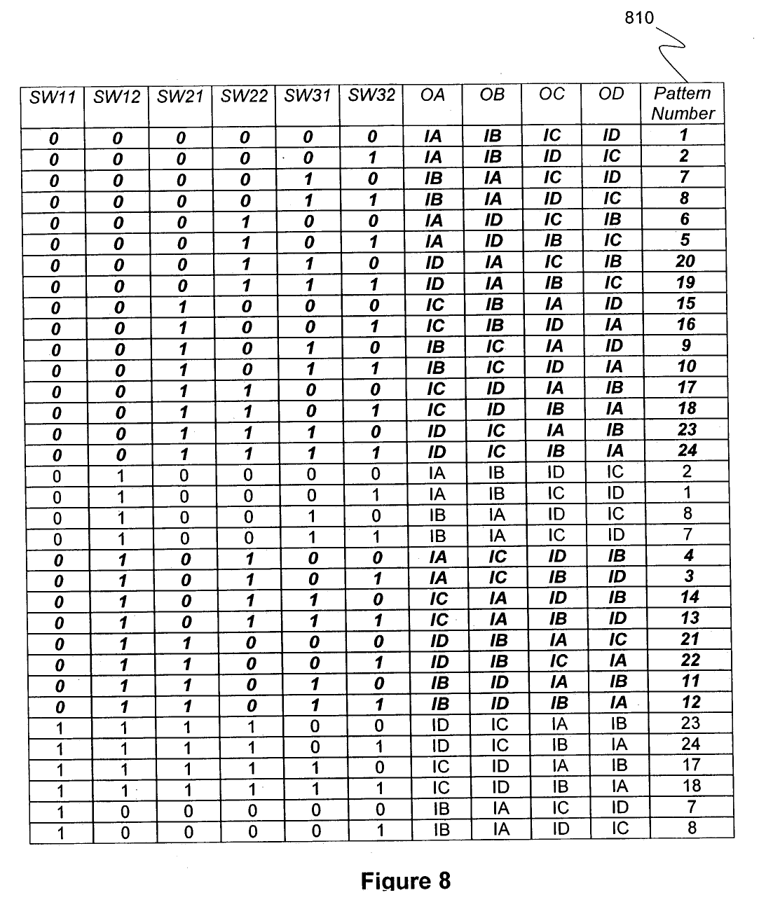

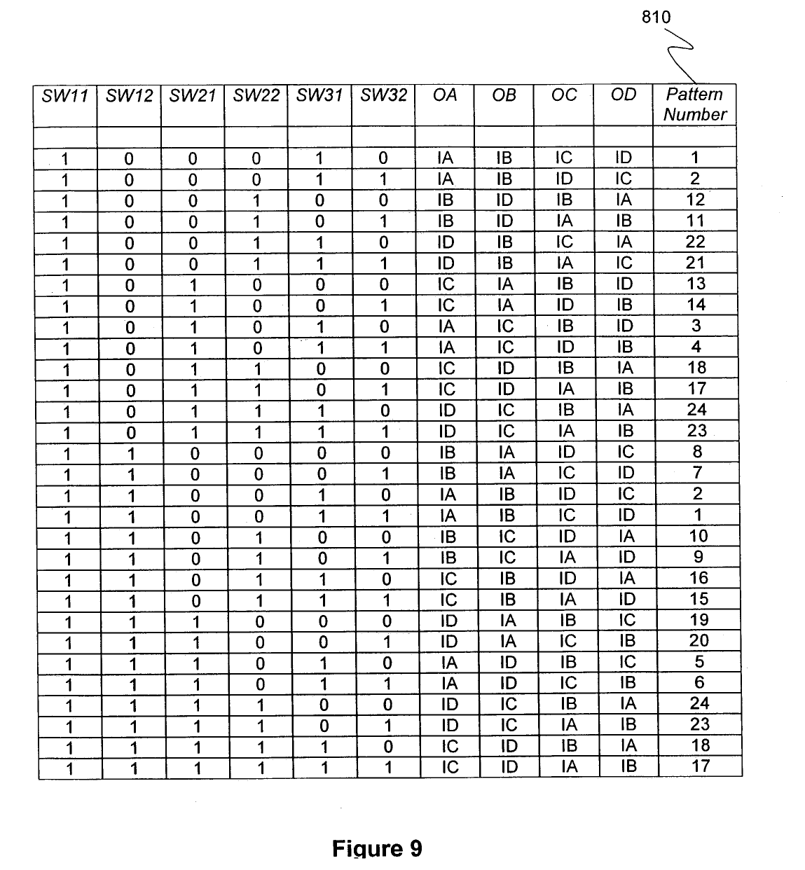

FIG. 7 shows input to output pattern mappings and a mapping assignment in accordance with one embodiment. Note that with a four input and four output swapper there are a total of 24 (24=4×3×2×1=4!) different combinations of input to output mappings. As noted in the discussion associated with FIG. 6, there are six configuration bits 622-632. FIGS. 8 and 9 together illustrate a truth table showing the different configurations bits possible (2⁶=64) and the corresponding input to output pattern mappings for this embodiment. The truth table indicates that there are a significant number of repeated pattern numbers 810 over all values of the configuration bits. (A pattern number is associated with a unique input-to-output mapping for swapper 320. For example, pattern number 7 corresponds to a mapping IB to OA, IA to OB, IC to OC, and ID to OD.)

Referring to the embodiment as shown in FIG. 6, a “0” configuration bit for a two-signal switching circuit results in a non-swap of the two inputs, whereas a “1” configuration bit induces a swap. Reviewing the table entries for input/output pattern combinations in FIG. 8, while holding SW11 at a “0”, one notes that all possible input/output pattern combinations occur (bolded-italicized rows). Since the case of holding SW11 at a “0” is the same as logically replacing SW11 with wires, it is possible to perform all input/output mappings with only five two-signal switching circuits as shown in FIG. 10. Further analysis of Tables 8 and 9 indicates that it is possible to remove any one of the six swappers and perform the complete input/output mapping. Empirical analysis can be verified with a more formal approach. There are 2⁶ (64) possible configuration combinations, utilizing 6 configuration bits. However, there are only twenty-four combinations required to perform all input/output pattern mappings. Since five configuration bits provide for 2⁵ (32) combinations, it follows that, while an embodiment uses six configuration bits, it is possible to provide for the twenty-four different input/output pattern mappings with five configuration bits with a variation of the embodiment.

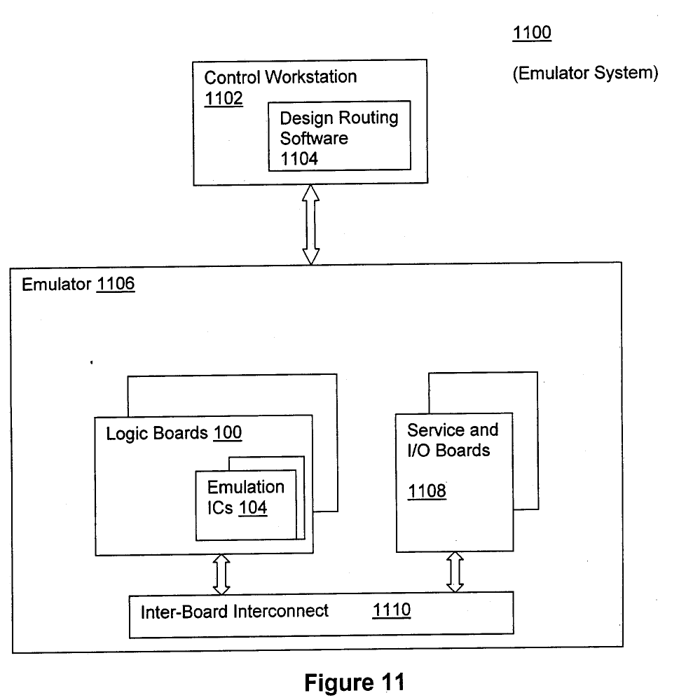

FIG. 11 shows a block diagram of an emulation system formed using logic boards 100. As illustrated, emulation system 1100 includes control workstation 1102 and emulator 1106. Control workstation 1102 is equipped with design routing software 1104. Emulator 1106 includes a number of logic boards 100, each having a number of emulation ICs 104, trace facilities (not shown) and reconfigurable interconnects 1110 disposed thereon. In addition to logic boards 100, emulator 1106 also includes service and I/O boards 1108. Boards 100 and 1108 are interconnected by inter-board interconnects 1110. In one embodiment, various boards 100 and 1108 are packaged together to form a “crate” (not shown), and the crates are interconnected together via inter-board interconnects 1110. The precise numbers of emulation ICs 104 disposed on each board, as well as the precise manner in which the various boards are packaged into crates, are not limited by the present invention and are application dependent. Design routing software 1104 may require modification for support of the swapping configuration logic in the RLEs as described herein. However, design routing software 1104 is otherwise intended to represent a broad range of the software typically supplied with an emulation system. Additionally, emulator 1106 is intended to represent a broad range of emulators known in the art.

Thus, a RLE equipped with an input line swapper, as well as an improved IC, logic board, and emulation system, along with methods associated therewith, have been described herein. While the apparatuses and methods of the present invention have been described in terms of the above illustrated embodiments, those skilled in the art will recognize that the various aspects of the present invention are not limited to the embodiments described. The present invention can be practiced with modification and alteration within the spirit and scope of the appended claims. The description is thus to be regarded as illustrative rather than restrictive of the present invention.

What is claimed is:

1. A reconfigurable logic element (RLE) as part of an integrated circuit for use in an emulation system comprising:
a reconfigurable logic portion to reconfigurably implement logic, said reconfigurable logic portion having N inputs; and
a coupling portion coupled to said reconfigurable logic portion, including N inputs, a multi-stage coupling network and N outputs, with said N outputs of said coupling portion correspondingly coupled to said N inputs of said reconfigurable logic portion, and said multi-stage coupling network configurably coupling said N inputs of said coupling portion to said N outputs of said coupling portion.

2. The RLE of claim 1 wherein said configurable coupling is bijective.

3. The RLE of claim 1 wherein said multistage coupling network is configurable separately from said reconfigurable logic portion.

4. The RLE of claim 1 wherein said multistage coupling network comprises a plurality of two-signal switching circuits.

5. The RLE of claim 1 wherein said multistage coupling network consists of five two-signal switching circuits.

6. The RLE of claim 1 wherein said multistage coupling network consists six two-signal switching circuits.

7. The RLE of claim 1, wherein said multistage coupling network is a swapper.

8. An integrated circuit for use in an emulation system comprising:
a plurality of reconfigurable logic elements (RLE), each RLE including:
a reconfigurable logic portion to reconfigurably implement logic, said reconfigurable logic portion having N inputs; and
a coupling portion coupled to said first logic, including N inputs, a multi-stage coupling network and N outputs, with said N outputs of said coupling portion correspondingly coupled to said N inputs of said reconfigurable logic portion, and said multi-stage coupling network configurably coupling said N inputs of said coupling portion to said N outputs of said coupling portion.

9. A method of emulating an electronic circuit, comprising:
(a) sending a netlist to an emulation system, said netlist being descriptive of said electronic circuit; and
(b) receiving results from said emulation system, wherein said results are based on processing said netlist by said emulation system, and wherein said emulation system comprises:
an emulator including at least one logic board comprising at least one integrated circuit, said at least one integrated circuit including at least one reconfigurable logic element (RLE), said at least one RLE including:
a first logic to reconfigurably implement logic, said first logic having N inputs; and
a second logic coupled to said first logic, including N inputs, a multi-stage coupling network and N outputs, with said N outputs of said second logic correspondingly coupled to said N inputs of said first logic, and said multi-stage coupling network configurably coupling said N inputs of said second logic to said N outputs of said second logic.

10. The method of claim 9, wherein said emulation system further comprises:
a workstation including design routing software to partition a design of said electronic circuit into a plurality of partitions.

11. A reconfigurable logic element (RLE) as part of an integrated circuit for use in an emulation system comprising:
a reconfigurable logic portion to reconfigurably implement logic, said reconfigurable logic portion having M inputs; and
a coupling portion coupled to said reconfigurable logic portion, including N inputs, a multi-stage coupling network and M outputs, with said M outputs of said coupling portion correspondingly coupled to said M inputs of said reconfigurable logic portion, and said multi-stage coupling network configurably and selectively coupling said N inputs of said coupling portion to said M outputs of said coupling portion.

12. A programmable logic device for use in an emulation system, comprising:
a plurality of reconfigurable logic elements; and
an interconnect network interconnecting the plurality of reconfigurable logic elements, the interconnect network including:
an input interface that accommodates N inputs;
an output interface that accommodates N outputs; and
a switching module coupled to said input interface and to said output interface and configured to bijectively map said N inputs to said N outputs.
